(19) United States
(12) Patent Application Publication
(10) Pub. No.: US 2011/0191065 A1
(43) Pub. Date: Aug. 4, 2011

(54) NETWORK-BASED MEDICAL TREATMENT SYSTEM

(75) Inventor: Hyung Chan KIM, Suwon-si (KR)

(73) Assignee: SAMSUNG ELECTRONICS CO., LTD., Suwon-si (KR)

(21) Appl. No.: 13/013,161

(22) Filed: Jan. 25, 2011

(30) Foreign Application Priority Data
Jan. 29, 2010 (KR) 10-2010-8696

(51) Int. Cl. G06F 19/00

(52) U.S. Cl. 702/188

(57) ABSTRACT

A network-based medical treatment system dynamically manages examination devices that perform medial examinations. The medical treatment system receives examination orders, allocates the examination orders to the examination devices, monitors the status of the examination devices, and manages examination results to efficiently process the examination orders.

### CROSS-REFERENCE TO RELATED APPLICATION(S)

This application claims priority from Korean Patent Application No. 2010-0008696, filed on Jan. 29, 2010 in the Korean Intellectual Property Office, the disclosure of which is incorporated herein by reference in its entirety.

### BACKGROUND

1. Field

Exemplary embodiments relate to a medical treatment system for constructing a plurality of medical devices over a network, and synthetically operating the medical devices.

2. Description of the Related Art

Most diagnostic (examination) devices for use in conventional medical instruments are standalone products. Conventional medical instruments do not include sufficient network infrastructure, such that the diagnostic devices cannot always support a networking function.

Network functions are gradually being introduced to medical diagnostic devices in compliance with environmental changes, such that medical diagnostic devices are becoming interoperable with hospital systems. Medical teams can monitor patient history using an Electronic Medical Record (EMR) terminal Personal Computer (PC) that is interoperable with medical facilities' central systems.

### SUMMARY

Exemplary embodiments provide a network-based medical treatment system for distributing examination orders generated from a medical system, which is interoperable with examination devices over a network, to suitable examination devices, and defining a process of several operations (e.g., an operation for automatically receiving the examination result and transmitting the received result to a server), such that the medical treatment system effectively manages examination orders.

Additional aspects will be set forth in the following description and, in part, will be obvious from the description, or may be learned by practice.

In accordance with an exemplary embodiment, a network-based medical treatment system includes a terminal device that generates an examination order, an examination device that receives generated the examination order over a network, and performs an examination corresponding to the received examination order, and a remote order manager that assigns the generated examination order to the examination device, transmits the assigned examination order to the examination device associated with the examination order over the network, and receives an examination result of the performed examination from the associated examination device.

The remote order manager may store the examination order generated by the terminal device in a new order queue.

The remote order manager may include a memory that stores the new order queue.

The new order queue may include a plurality of queues, the examination device may include a plurality of examination devices, and a number of the plurality of queues may be equal to a number of examination device types among the plurality of examination devices.

The remote order manager may store a current analysis order queue that includes a list of examination orders currently being processed in the examination device.

The remote order manager may, in response to receiving the examination result of the examination device, may remove the examination order corresponding to the examination from the current analysis order queue, and transfer a new examination order stored in the new order queue to the current analysis order queue.

The new order queue may include a plurality of queues, the examination device comprises a plurality of examination devices, and a number of the plurality of queues may be equal to a number of examination device types among the plurality of examination devices.

Each of the plurality of queues may include a number of entries equal to a number of examination devices among the plurality of examination devices that correspond to a type of examination.

The remote order manager may further include a remote order scheduler that receives the examination order from the terminal device, stores the received examination order in one of the new order queue or the current analysis order queue.

The remote order scheduler may determine a state of the current analysis order queue and transfer an examination order of the new order queue to the current analysis order queue in response to the determining.

The remote order manager may further include an examination result manager that, upon completion of the examination of the examination device, transmits the examination result received from the corresponding examination device to the terminal device.

The examination result manager may receive the examination result and store the received examination result in a database.

The remote order manager may further include a device state buffer that stores state information of each of the plurality of examination devices to recognize a current state of each of the plurality of examination devices.

The device state buffer may include a plurality of device state buffers, and a number of the plurality of device state buffers is equal to a number of the plurality of examination devices.

Each of the plurality of device state buffers may include a number of entries equal to a number of the plurality of examination devices corresponding to a type of examination.

The state information of the examination device may include an examination device ID field, a local examination number field, a high-priority local task number field, a quality control field, a residual examination time field, an operator field, an examination type field, and an examination policy field.

The examination device ID field may identify a unique ID of the examination device.

The state field may indicate a current state of the examination device.

The state field may identify the current state of the examination device on the basis of reference information that includes information about at least one of an idle state, an analyzing state, an abnormal state, and a disabled state.

The local examination number field may indicate a number of unprocessed local examination orders input through a user interface of the examination device.

The high priority local task number field may indicate a number of high-priority examination orders from among idle-state examination orders of the examination device.

The quality control field may indicate quality management frequency and time of the examination device.

The residual examination time field may indicate a residual time required by the examination device to complete the examination order.

The operator field may indicate an operator who operates the examination device.

The examination type field may indicate a type of the examination.

The examination policy field may indicate a processing priority of a local examination order locally input at the examination device and the examination order.

The remote order manager may further include a state monitor that periodically collects state information of the examination device and updates content data of the device state buffer.

The examination device, in response to completing the examination order, may transmit changed state information to the device state monitor.

The terminal device may include a user interface that accepts the examination order from a user.

The examination may be medical treatment.

The terminal device and the remote order manager may be installed independently of each other.

The terminal device and the remote order manager may be implemented as one device.

### BRIEF DESCRIPTION OF THE DRAWINGS

The above and/or other aspects will become apparent and more readily appreciated from the following description of exemplary embodiments, taken in conjunction with the accompanying drawings, of which:

FIG. 1 is a conceptual diagram illustrating a network-based medical treatment system, according to an exemplary embodiment.

FIG. 2 is a structural view illustrating a remote order manager shown in FIG. 1, according to an exemplary embodiment.

FIG. 3 is a detailed block diagram illustrating a remote order manager and examination device shown in FIG. 2.

FIG. 4 is a structural diagram illustrating state information of examination devices, according to an exemplary embodiment.

FIG. 5 is a flowchart illustrating a method for allocating a new order (an examination order), required for an operation, in which an examination order newly generated from a terminal device of a network-based medical treatment system is transmitted to an examination device, according to an exemplary embodiment.

FIG. 6 is a flowchart illustrating a method of processing examination results and state information, when an examination device of a network-based medical treatment system finishes an examination operation, according to an exemplary embodiment.

FIG. 7 is a flowchart illustrating a method for collecting and analyzing information of an examination device in a network-based medical treatment system, according to an exemplary embodiment.

### DETAILED DESCRIPTION

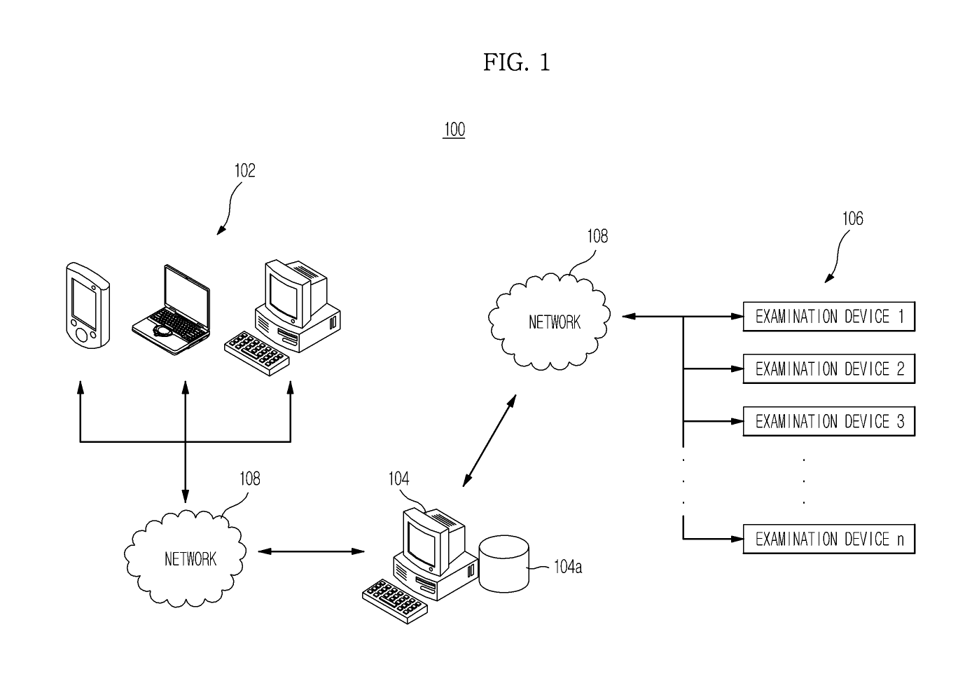

Reference will now be made in detail to the exemplary embodiments, examples of which are illustrated in the accompanying drawings, wherein like reference numerals refer to like elements throughout. The exemplary embodiments will hereinafter be described with reference to FIGS. 1 to 7.

FIG. 1 is a conceptual diagram illustrating a network-based medical treatment system according to an exemplary embodiment. Referring to FIG. 1, a network-based medical treatment system 100 according to an exemplary embodiment interconnects a terminal device 102, a remote order manager 104, and examination devices 106 over a network 108, such that the terminal device 102, the remote order manager 104, and the examination devices 106 can communicate with one another over the network 108.

The terminal device 102 may be a personal digital assistant (PDA), a laptop computer, a desktop computer, or the like, that is capable of being carried by doctors or nurses of medical teams, such that the medical teams can command and generate medical examination orders using the terminal device 102. For example, assuming that the medical team decides to perform a blood test upon a patient, the medical treatment system 100 generates an examination order for requesting the blood test through the terminal device 102. This examination order is transmitted to the remote order manager 104 over the network 108. If necessary, one or more terminal devices 102 may be operated.

The medical order manager 104 receives the examination order from the terminal device 102, transmits the examination order to the corresponding examination device 106, and allocates an examination task to each examination device 106. The remote order manager 104 periodically communicates with each examination device 106 to perform smooth allocation of examination tasks, receives current state information of each examination device 106, and manages the received state information. In addition, the remote order manager 104 performs a variety of data management operations, for example, operations for receiving the examination result from the examination device 106 that has completed the corresponding examination, storing the received examination result in a database (DB) 104a, and transmitting the stored examination result to the terminal device 102. Specifically, in the case of operating several examination devices 106, provided that current state of each examination device 106 is managed in real time through the remote order manager 104, the medical treatment system 100 easily and quickly checks state information of an idle examination device, which is not currently carrying out an examination operation, from among several examination devices 106, and allocates an examination order to the idle examination device, such that the examination devices 106 can quickly and effectively carry out necessary examination tasks.

The examination devices 106 provide medical care or various examinations (or diagnoses) associated with the medical care. There are various types of examination devices 106, for example, blood testing devices, urine examination devices, radiological imaging devices, magnetic resonance imaging (MRI) devices, and the like. Each examination device 106 receives an examination order from the remote order manager 104, and carries out a corresponding examination. If the corresponding examination is completed, the examination device 106 transmits the examination result to the remote order manager 104. In order to allow the remote order manager 104 to smoothly allocate an examination order, whenever a current state (e.g., an idle state or an analyzing state) of the examination device 106 is changed to another state, the examination device 106 transmits information that indicates the changed current state to the remote order manager 104. One or more examination devices 106 may be operated as necessary.

Although the network-based medical treatment system 100 shown in FIG. 1 illustrates the terminal device 102 and the remote order manager 104 as being separate from each other, the terminal device 102 may operate as the remote order manager 104. That is, the operating application for the remote order manager 104 may be installed and operated in each terminal device 102 as necessary. In this case, provided that several terminal devices 102 are used, the communication priority may be assigned to individual terminal devices, or a primary terminal device from among several terminal devices is determined so that communication among several terminal devices may also be controlled through the primary terminal device.

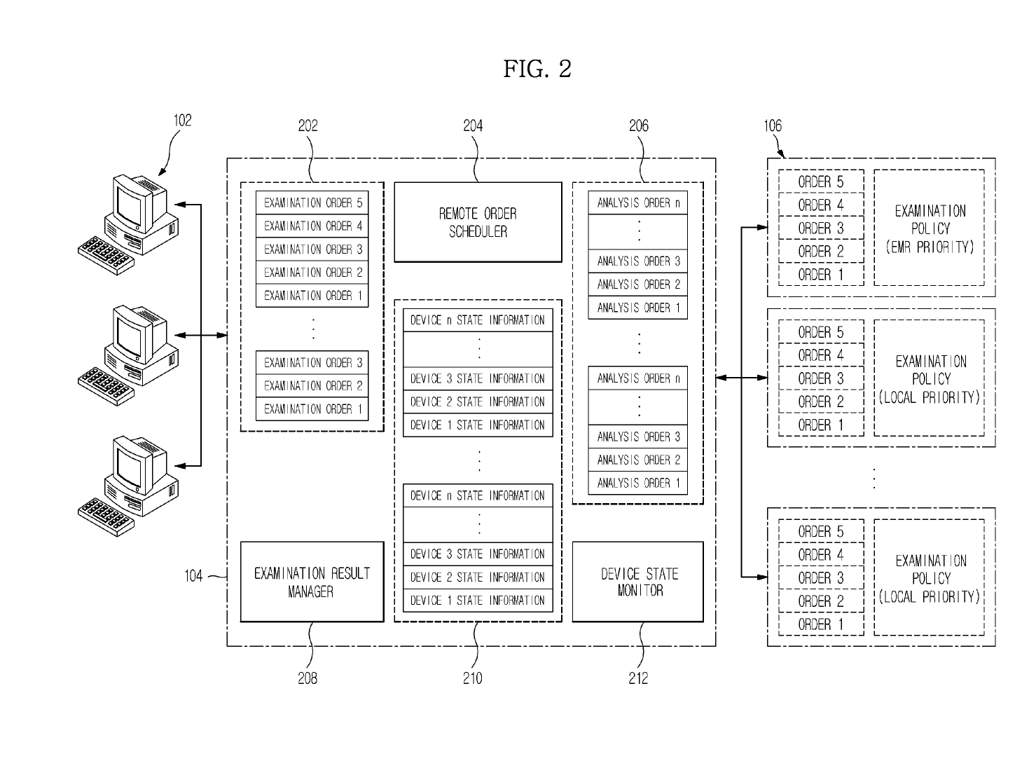

FIG. 2 is a structural view illustrating the remote order manager 104 shown in FIG. 1. Referring to FIG. 2, the remote order manager 104 includes a new order queue 202, a remote order scheduler 204, a current analysis order queue 206, an examination result manager 208, a device state buffer 210, and a device state monitor 212.

The new order queue 202 initially stores an examination order received from the terminal device 102.

The remote order scheduler 204 receives an examination order from the terminal device 102, stores the received examination order in the new order queue 202 or the current analysis order queue 206. In more detail, the remote order scheduler 204 monitors state information of the current analysis order queue 206 in real time, and transfers an examination order of the new order queue 202 to the current examination order queue 206.

The current analysis order queue 206 manages the list of examination orders that are currently being processed in the examination device 106 present on the network. If the examination device 106 has completed one examination task, an examination order of the corresponding examination task is removed from the current analysis order queue 206, such that a new examination order is transferred from the new order queue 202 to the empty space of the current analysis order queue 206 by the remote order scheduler 204, resulting in the removal of the empty space.

After the examination device 106 finishes the corresponding examination, the examination result manager 208 receives an examination result from the corresponding examination device 106, and transmits the received examination result to the terminal device 102 or stores the received examination result in the database (DB) 104a.

The device state buffer 210 stores state information of each examination device 106, such that a user can easily recognize current state information of each examination device 106.

The device state monitor 212 periodically receives and collects state information of the examination device 106, such that the device state monitor 212 updates content data stored in the device state buffer 208. For example, if state information of the examination device 106 is changed, the examination device 106 transmits the changed state information to the device state monitor 210 so as to inform the device state monitor 210 of the change of state information of the examination device 106.

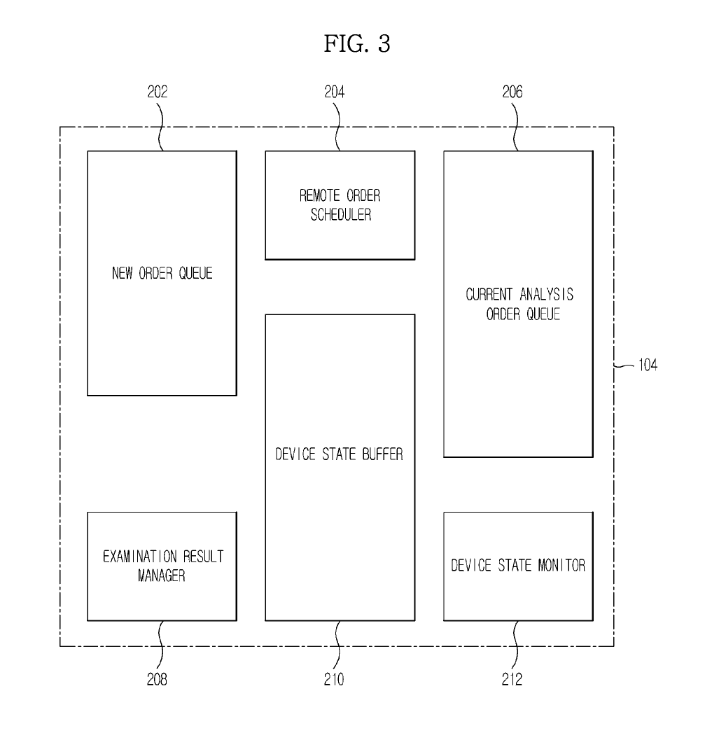

FIG. 3 is a detailed block diagram illustrating the remote order manager and the examination devices shown in FIG. 2. Specifically, FIG. 3 shows the new order queue 202, the current analysis order queue 206, and the device state buffer 210 contained in the remote order manager 104, and individual examination devices 106.

Referring to FIG. 3, the new order queue 202 of the remote order manager 104 stores an examination order newly received from the terminal device 102, and is present in a memory of the remote order manager 104. Preferably, the number of queues contained in the new order queue 202 may be identical to the number of examination devices 106. For example, provided that two kinds of examination devices 106, i.e., the urine examination device and the blood testing device, are interconnected over the network 108, the new order queue 202 has a queue for orders associated with the urine examination and a queue for orders associated with the blood examination.

The current analysis order queue 206 is a queue that stores the list of examination orders that are currently being processed by the current examination device 106. If the examination device 106 finishes the corresponding examination, the associated examination order is removed from the current analysis order queue 206, a new examination order stored in the new order queue 202 is transferred to the empty space corresponding to the location of the removed examination order, such that the empty space is filled with the new examination order. Preferably, the number of queues contained in the current analysis order queue 206 may be identical to the number of examination devices 106. Specifically, the number of entries of each queue may be identical to the number of examination devices 106. For example, two kinds of examination devices 106, i.e., the blood testing device and the urine examination device, are interconnected over the network 108. In addition, provided that five urine examination devices and five blood testing devices are used, the number of current analysis order queues 206 is set to 2, and each queue includes 5 entries.

The device state buffer 210 stores state information of the examination device 106 collected from the device state monitor 212. Preferably, the number of device state buffers 210 may also be identical to the number of examination devices 106. Specifically, the number of entries of each queue may be identical to the number of examination devices 106. For example, assuming that two examination devices 106, i.e., the blood testing device and the urine examination device, are interconnected over the network 108 and five urine examination devices and five blood testing devices are used, the number of device state buffers 206 is set to 2, and each buffer includes 5 entries.

The examination device 106 includes the remote examination order allocated from the remote order manager 104 and a local examination order queue for local examination orders directly generated through a user interface. The examination device 106 first processes the higher-priority one of the remote examination order and the local examination order. The priorities of the remote examination order and the local examination order are determined according to policy values. If the examination policy indicates ‘EMR priority’, the remote examination order is carried out first. If the examination policy indicates ‘Local Priority’, the local examination order is carried out first.

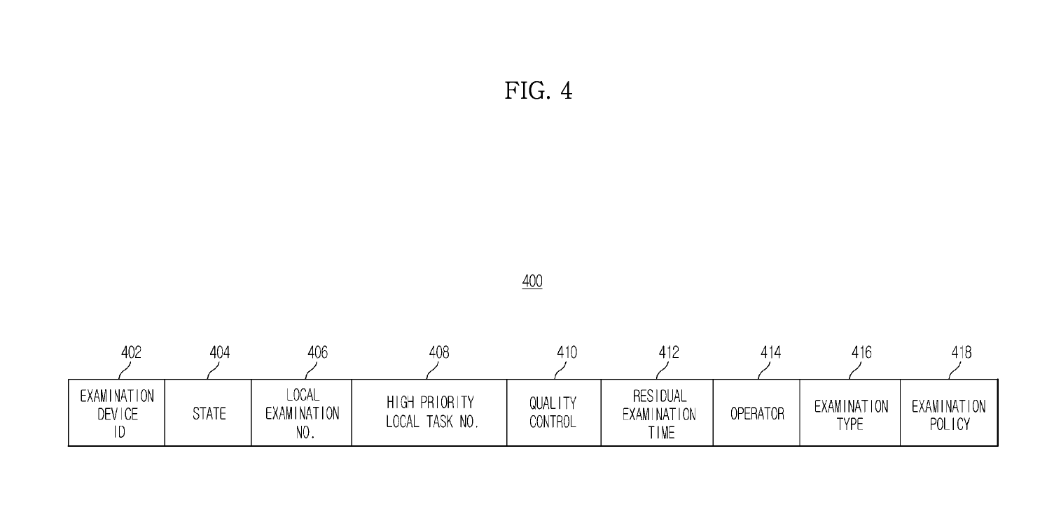

FIG. 4 is a structural diagram illustrating state information of examination devices according to an exemplary embodiment. Referring to FIG. 4, the state information 400 is stored in the device state buffer 210, and is managed by the device state monitor 212. The state information 400 includes an examination device ID field 402, a state field 404, a ‘local examination No’ field 406, a ‘high priority local task No’ field 408, a quality control field 410, a residual examination time field 412, an operator field 414, an examination type field 416, and an examination policy field 418.

The examination device ID field 402 is a unique ID that identifies an examination device 106. In accordance with the exemplary embodiments, each examination device 106 is identified by the examination device ID field 402. A new examination order may be transferred to a specific examination device 106, or state information or examination results may be received from the specific examination device 106.

The state field 404 is a field for indicating a current state of an examination device 106. The current state of the examination device 106 may be classified into an idle state, an analyzing state, an abnormal state, a disabled state, and the like. The idle state indicates that the examination device 106 is not performing an examination. In the idle state, upon receiving a new examination order, the examination corresponding to the received examination order can be immediately carried out. The analyzing state indicates that the examination device 106 has received a specific examination order and the examination corresponding to the received examination order is currently being processed. The abnormal state indicates that it is impossible for normal and reliable examination results to be provided due to the occurrence of some problems, although the examination is currently being executed or can be executed. The disabled state indicates that the examination device 106 is unable to perform normal examination.

The local examination No. field 406 indicates the number of local examination orders that are directly generated through a user interface of the examination device 106, instead of through the remote examination order transferred through the remote order manager 104, and remain in an idle state in a local examination order queue of the examination device 106.

The high priority order local task No. field 408 indicates the number of high-priority orders from among examination orders that are in the idle state in the local examination order queue contained in the examination device 106.

The quality control field 410 indicates whether the corresponding examination device 106 is being managed through a quality control action. That is, the quality control field 410 indicates the quality management frequency or time, distinguishes between one examination device, quality control of which is performed well, and the other examination device, quality control of which is not performed or was performed long ago, such that one the well-quality-controlled examination device is used for examination first. This results in increased reliability of the examination result.

The residual examination time field 412 indicates a residual time required for the completion of the examination order being currently processed in the examination device 106. When all the examination devices 106 perform their assigned examinations, the residual examination time field 412 can inform a user (e.g., doctor) which of the examination devices 106 will finish examination first, such that examination orders can be more effectively and quickly assigned to the examination devices 106.

The operator field 414 indicates an operator who performs an examination using the corresponding examination device 106.

The examination type field 416 indicates the type of a corresponding examination. For example, in the case of the blood testing, the examination type field 416 indicates whether the blood testing is an immune function test, a clinical chemistry test, or the like.

The examination policy field 418 indicates whether the corresponding examination device 106 will first process a local examination order in the local examination order queue self-generated from the examination device, or will first process the remote examination order assigned through the remote order manager 104. The examination policy field 418 is matched with the examination policy field 418 of the examination device 106.

Additionally, much more information is defined according to examination device types, medical facility conditions, and the like, such that the defined information can be used as information for managing the examination device 106 present on the network 108.

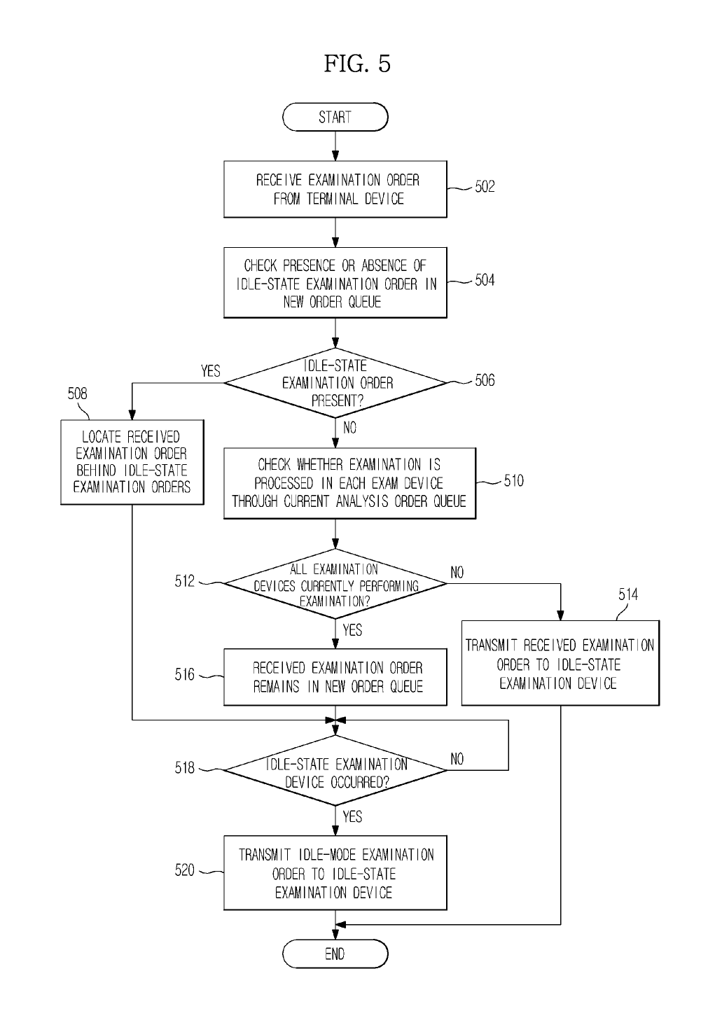

FIG. 5 is a flowchart illustrating a method for allocating a new order (an examination order) required for an operation, in which an examination order newly generated from a terminal device of a network-based medical treatment system is transmitted to an examination device, according to an exemplary embodiment. Referring to FIG. 5, the remote order manager 104 receives an examination order newly generated by a medical treatment specialist (e.g., doctor), who handles the terminal device 102, from the terminal device 102 over the network 108, at operation 502. The remote order scheduler 204, acting as an internal constituent element of the remote order manager 104, determines whether an idle-state examination order is in the new order queue 202, at operation 504. If the presence of the idle-state examination order in the new order queue 202 is determined, at operation 506, the received examination order is placed at the rearmost position of conventional examination orders that remain in an idle state in the new order queue 202, at operation 508. Otherwise, if the absence of the idle-state examination order in the new order queue 202 is determined, at operation 506, it is determined whether there is an examination that is currently being performed in each examination device 106 through the current analysis order queue 206, at operation 510. If the idle-state examination device, which is not performing an examination, is present among the examination devices 106, at operation 512, the received examination order is transmitted to the idle-state examination device 106, and the process for transmitting the examination order is completed, at operation 514. In contrast, if all the examination devices 106 are currently performing examination at operation 512, the received examination order remains in the new order queue 202, at operation 516. Under this condition, if the current examination is completed and the examination device in the idle state is generated, at operation 518, the examination order that is in an idle state in the new order queue 202 is transferred to the idle-state examination device 106, at operation 520. The operation for transmitting the examination order from the new order queue 202 to the examination device 106 may use a First In First Out (FIFO) scheme or may follow the priority assigned to each examination order.

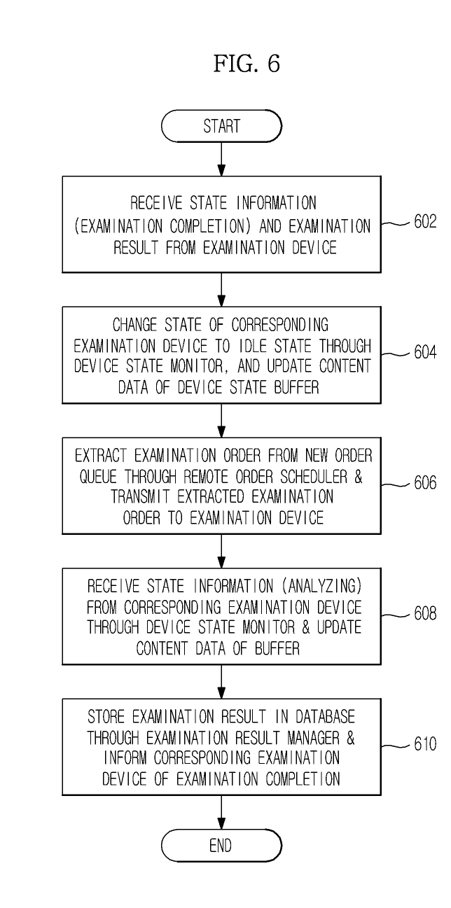

FIG. 6 is a flowchart illustrating a method for processing an examination result and state information when an examination device of a network-based medical treatment system finishes an examination operation according to an exemplary embodiment. Referring to FIG. 6, if the examination device 106 completes the examination, the remote order manager 104 receives state information indicating the completion of examination and the examination result from the examination device 106 at operation 602. The device state monitor 212 changes a current state of the corresponding examination device 106 having completed the examination to an idle state, and updates contents of the device state buffer 210 by reflecting the changed result at operation 604. Because the idle-state examination device 106 has occurred, the remote order manager 104 extracts the idle-state examination order from the new order queue 202 through the remote order scheduler 204, inputs the extracted examination order to the current analysis order queue 206, and transmits and assigns the corresponding examination order to the idle-state examination device 106 at operation 606. In this case, the operation for transmitting the examination order from the new order queue 202 to the examination device 106 may use a FIFO scheme or may follow the priority assigned to each examination order. The examination device 106 starts an examination corresponding to the newly assigned examination order, changes its own state information to an analyzing state, and transmits the state information to the remote order manager 104. The remote order manager 104 receives the changed state information from the examination device 106 through the device state monitor 212, and updates content data of the device state buffer 210 at operation 608. If the examination device 106 finishes the examination, the remote order manager 104 stores the corresponding examination result in the database through the examination result manager 208, and informs the corresponding examination device 106 of examination completion at operation 610.

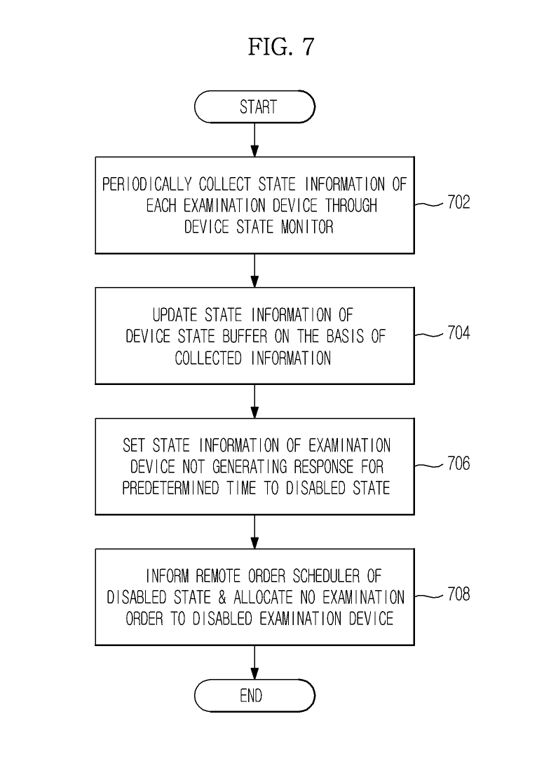

FIG. 7 is a flowchart illustrating a method for collecting and analyzing information of the examination device in the network-based medical treatment system according to an exemplary embodiment. Referring to FIG. 7, the remote order management 104 collects information of the examination device 106 through the device state monitor 212 according to the following method, and analyzes the collected information.

The remote order manager 104 periodically collects state information of each examination device 106 through the device state monitor 212 at operation 702. In this way, the remote order manager 104 updates content data of the device state buffer 210 on the basis of the collected information at operation 704. If a specific examination device 106 that does not respond to the periodically executed operation for a predetermined period of time, state information of the corresponding examination device 106 is changed to a disabled state at operation 706. In addition, the remote order manager 104 informs the remote order scheduler 204 of the disabled state of the examination device 106, such that the remote order scheduler 204 does not assign an examination order to the disabled examination device 106 at operation 708.

As is apparent from the above description, the network-based medical treatment system according to the exemplary embodiments distributes examination orders generated from a medical system, which is interoperable with examination devices over a network, to suitable examination devices, and defines a process of several operations (e.g., an operation for automatically receiving the examination result and transmitting the received result to a server), such that the medial treatment system effectively manages examination orders. In addition, the network-based medical treatment system reduces an examination time and effectively manages the examination result.

Although a few exemplary embodiments have been shown and described, it would be appreciated by those skilled in the art that changes may be made in these exemplary embodiments without departing from the principles and spirit of the invention, the scope of which is defined in the claims and their equivalents.

What is claimed is:

1. A network-based medical treatment system comprising:
a terminal device that generates an examination order;
an examination device that receives the generated examination order over a network, and performs an examination corresponding to the received examination order; and
a remote order manager that assigns the generated examination order to the examination device, transmits the assigned examination order to the examination device associated with the examination order over the network, and receives an examination result of the performed examination from the associated examination device.

2. The network-based medical treatment system according to claim 1, wherein the remote order manager stores the examination order generated by the terminal device in a new order queue.

3. The network-based medical treatment system according to claim 2, wherein the remote order manager comprises a memory that stores the new order queue.

4. The network-based medical treatment system according to claim 2, wherein the new order queue includes a plurality of queues, the examination device comprises a plurality of examination devices, and a number of the plurality of queues is equal to a number of examination device types among the plurality of examination devices.

5. The network-based medical treatment system according to claim 2, wherein the remote order manager stores a current analysis order queue that includes a list of examination orders currently being processed in the examination device.

6. The network-based medical treatment system according to claim 5, wherein the remote order manager, in response to receiving the examination result of the examination device, removes the examination order corresponding to the examination from the current analysis order queue, and transfers a new examination order stored in the new order queue to the current analysis order queue.

7. The network-based medical treatment system according to claim 5, wherein the new order queue includes a plurality of queues, the examination device comprises a plurality of examination devices, and a number of the plurality of queues is equal to a number of examination device types among the plurality of examination devices.

8. The network-based medical treatment system according to claim 7, wherein each of the plurality of queues includes a number of entries equal to a number of examination devices among the plurality of examination devices that correspond to a type of examination.

9. The network-based medical treatment system according to claim 5, wherein the remote order manager includes a remote order scheduler that receives the examination order from the terminal device, stores the received examination order in one of the new order queue or the current analysis order queue.

10. The network-based medical treatment system according to claim 9, wherein the remote order scheduler determines a state of the current analysis order queue and transfers an examination order of the new order queue to the current analysis order queue in response to the determining.

11. The network-based medical treatment system according to claim 9, wherein the remote order manager includes an examination result manager that, upon completion of the examination of the examination device, transmits the examination result received from the corresponding examination device to the terminal device.

12. The network-based medical treatment system according to claim 11, wherein the examination result manager receives the examination result and stores the received examination result in a database.

13. The network-based medical treatment system according to claim 11, wherein the remote order manager includes a device state buffer that stores state information of each of the plurality of examination devices to recognize a current state of each of the plurality of examination devices.

14. The network-based medical treatment system according to claim 13, wherein the device state buffer includes a plurality of device state buffers, and a number of the plurality of device state buffers is equal to a number of the plurality of examination devices.

15. The network-based medical treatment system according to claim 14, wherein each of the plurality of device state buffers includes a number of entries equal to a number of the plurality of examination devices corresponding to a type of examination.

16. The network-based medical treatment system according to claim 13, wherein the state information of the examination device includes an examination device identifier (ID) field, a local examination number field, a high-priority local task number field, a quality control field, a residual examination time field, an operator field, an examination type field, and an examination policy field.

17. The network-based medical treatment system according to claim 16, wherein the examination device ID field identifies a unique ID of the examination device.

18. The network-based medical treatment system according to claim 16, wherein the state field indicates a current state of the examination device.

19. The network-based medical treatment system according to claim 18, wherein the state field identifies the current state of the examination device on the basis of reference information that includes information about at least one of an idle state, an analyzing state, an abnormal state, and a disabled state.

20. The network-based medical treatment system according to claim 16, wherein the local examination number field indicates a number of unprocessed local examination orders input through a user interface of the examination device.

21. The network-based medical treatment system according to claim 16, wherein the high priority local task number field indicates a number of high-priority examination orders from among idle-state examination orders of the examination device.

22. The network-based medical treatment system according to claim 16, wherein the quality control field indicates quality management frequency and time of the examination device.

23. The network-based medical treatment system according to claim 16, wherein the residual examination time field indicates a residual time required by the examination device to complete the examination order.

24. The network-based medical treatment system according to claim 16, wherein the operator field indicates an operator who operates the examination device.

25. The network-based medical treatment system according to claim 16, wherein the examination type field indicates a type of the examination.

26. The network-based medical treatment system according to claim 16, wherein the examination policy field indicates a processing priority of a local examination order locally input at the examination device and the examination order.

27. The network-based medical treatment system according to claim 13, wherein the remote order manager further includes a state monitor that periodically collects state information of the examination device and updates content data of the device state buffer.

28. The network-based medical treatment system according to claim 27, wherein the examination device, in response to completing the examination order, transmits changed state information to the device state monitor.

29. The network-based medical treatment system according to claim 1, wherein the terminal device includes a user interface that accepts the examination order from a user.

30. The network-based medical treatment system according to claim 1, wherein the examination is medical treatment.

31. The network-based medical treatment system according to claim 1, wherein the terminal device and the remote order manager are installed independently of each other.

32. The network-based medical treatment system according to claim 1, wherein the terminal device and the remote order manager are implemented as one device.
